(19) United States
(12) Patent Application Publication
(10) Pub. No.: US 2012/0038873 A1
(43) Pub. Date: Feb. 16, 2012

(54) Reflection-type liquid crystal display device

(76) Inventors: Jae-Hyun Kim, Yongin-City (KR); Won-Sang Park, Yongin-City (KR); Jae-Ik Lim, Yongin-City (KR); Jong-In Baek, Yongin-City (KR); Gee-Bum Kim, Yongin-City (KR); Yong-Seok Yeo, Yongin-City (KR)

(21) Appl. No.: 13/064,478

(22) Filed: Mar. 28, 2011

(30) Foreign Application Priority Data
Aug. 11, 2010 (KR) 10-2010-0077495

(51) Int. Cl. G02F 1/1333

(52) U.S. Cl. 349/138

(57) ABSTRACT

A liquid crystal display device, including a first substrate, a thin-film transistor on the first substrate and including a gate electrode, a gate insulating layer, an active layer, and source and drain electrodes, an organic insulating layer on the thin-film transistor, a first electrode layer on the organic insulating layer, the first electrode layer extending between respective portions of the organic insulating layer to contact the source and drain electrode, a black layer on the first electrode layer and the organic insulating layer, a liquid crystal layer on the black layer, a second electrode layer on the liquid crystal layer, and a second substrate on the second electrode layer. The liquid crystal may include a cholesteric liquid crystal layer or a polymer network liquid crystal (PNLC).

### BACKGROUND

1. Field

Embodiments relate to a liquid crystal display device, and more particularly, to a reflection-type liquid crystal display device.

2. Description of the Related Art

Liquid crystal display devices are display devices that display images by adjusting transmittance and reflectance of light by controlling the molecular alignment of liquid crystal. Due to low electric power consumption and relatively low weight of liquid crystal display devices, such liquid crystal display devices may be widely applied to cellular phones, digital cameras, portable information appliances, large size TVs, etc.

Liquid crystal display devices are classified into transmission-type liquid crystal display devices and reflection-type liquid crystal display devices according to a light source thereof. Transmission-type liquid crystal display devices realize images by transmitting light from a backlight through a liquid crystal panel. Reflection-type liquid crystal display devices realize images by reflecting external light at a liquid crystal panel.

The transmission-type liquid crystal display devices have relatively low efficiency of light utilization since about ⅕ of light from the backlight transmits through the liquid crystal panel. Transmission-type liquid crystal display devices also consume relatively high electric power since over ⅔ of the total electric power is generally consumed by the backlight.

Reflection-type liquid crystal display devices use external light rather than a light source. Thus, electric power consumption thereof may be reduced compared to transmission type liquid crystal display devices. In general, a reflection-type liquid crystal display device includes an array substrate including a switching device, a pixel electrode, and a reflective layer, an opposite substrate including a common electrode, a color filter, and a black matrix, and liquid crystal disposed between the array substrate and the opposite substrate. The black matrix of the opposite substrate may prevent light leakage at boundaries of pixels and may improve a reflection contrast ratio.

### SUMMARY

It is a feature of an embodiment to provide a reflection-type liquid crystal display device having high aperture ratio and contrast ratio.

It is a separate feature of an embodiment to provide a liquid crystal display device having an improved aperture ratio, e.g., higher aperture ratio, which is a ratio of emission zone per pixel, in order to increase brightness of a screen of the liquid crystal display device and reduce electric power consumption.

It is a separate feature of an embodiment to provide a liquid crystal display device having a structure such that misalignment of the black matrix during assembly of the array substrate and the opposite substrate may be reduced so as to enable an improved aperture ratio.

At least one of the above and other features and advantages may be realized by providing a liquid crystal display device, including a first substrate, a thin-film transistor on the first substrate, the thin-film transistor including a gate electrode, a gate insulating layer, an active layer, and source and drain electrodes, an organic insulating layer on the thin-film transistor, a first electrode layer on the organic insulating layer, the first electrode layer extending between respective portions of the organic insulating layer to contact the source and drain electrode, a black layer on the first electrode layer and the organic insulating layer, a liquid crystal layer on the black layer, a second electrode layer on the liquid crystal layer, and a second substrate on the second electrode layer.

The organic insulating layer may include a transparent organic insulating layer.

The organic insulating layer may include a black organic insulating layer.

The organic insulating layer may include a surface having a convex lens shape.

The display device may further include a passivation layer between the thin-film transistor and the organic insulating layer.

The black layer may be arranged over an entire surface of the first substrate.

The black layer may only be arranged over a portion of a surface of the first substrate.

The black layer may be arranged over a portion of a surface of the first substrate corresponding to boundaries of pixels.

The black layer may include an organic insulating material or carbon black.

The first electrode layer may be a pixel electrode.

The second electrode layer may be a common electrode.

The liquid crystal layer may include a cholesteric liquid crystal layer.

The liquid crystal layer may include a polymer network liquid crystal (PNLC).

Dyes may be dispersed in the PNLC.

The display device may further include a color filter on the second substrate._{,}

The black layer may be arranged on the first substrate before the second substrate is arranged on the first substrate.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a cross-sectional view of a pixel of a liquid crystal display device according to an exemplary embodiment;

FIG. 2 illustrates a cross-sectional view of a pixel of a liquid crystal display device according to another exemplary embodiment;

FIG. 3 illustrates a cross-sectional view of a pixel of a liquid crystal display device according to another exemplary embodiment;

FIG. 4 illustrates a cross-sectional view of a pixel of a liquid crystal display device according to another exemplary embodiment;

FIG. 5 illustrates a cross-sectional view of a pixel of a liquid crystal display device according to another exemplary embodiment;

FIG. 6 illustrates a cross-sectional view of a pixel of a liquid crystal display device according to another exemplary embodiment;

FIG. 7 illustrates a cross-sectional view of a pixel of a liquid crystal display device according to another exemplary embodiment; and

FIG. 8 illustrates a cross-sectional view of a pixel of a reflection liquid crystal display device according to another exemplary embodiment.

### DETAILED DESCRIPTION

Korean Patent Application No. 10-2010-0077495, filed on Aug. 11, 2010, in the Korean Intellectual Property Office, and entitled: “Reflection-Type Liquid Crystal Display Device,” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when an element is referred to as being “on,” “above”, “below,” or “under” another element, it can be directly “on,” “above”, “below,” or “under” the other element, respectively, or intervening elements may also be present. In addition, it will also be understood that when an element is referred to as being “between” two elements, it can be the only element between the two elements, or one or more intervening elements may also be present.

It will be also be understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. Like reference numerals refer to like elements throughout the specification.

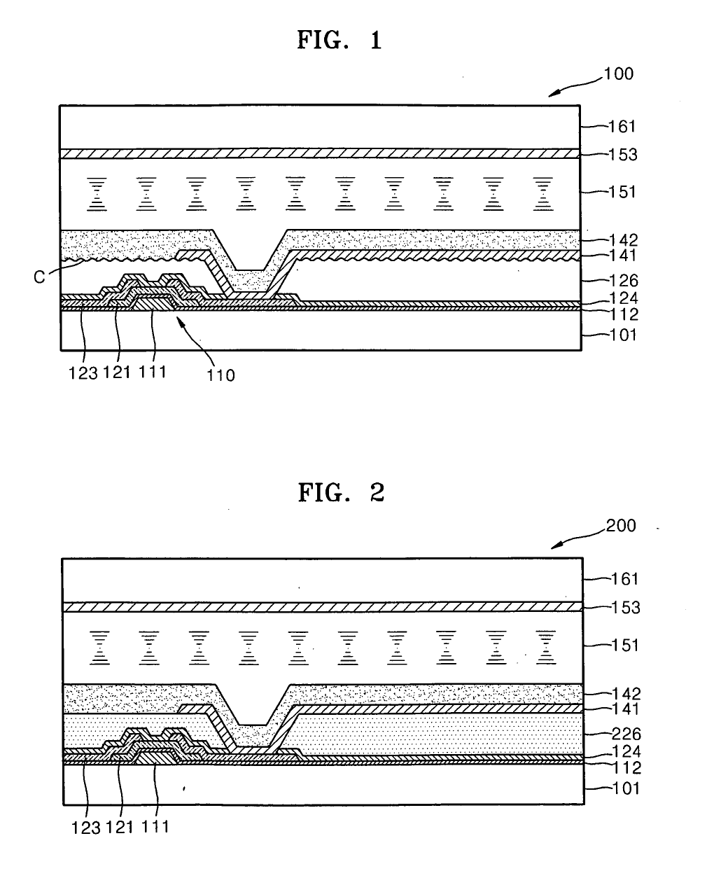

FIG. 1 illustrates a cross-sectional view of a pixel 100 of a reflection-type liquid crystal display device including a cholesteric liquid crystal according to an exemplary embodiment.

Referring to FIG. 1, the pixel 100 may include a first substrate 101, a thin film transistor (TFT) 110 including a gate electrode 111, a gate insulating layer 112, an active layer 121, and source/drain electrodes 123, a passivation layer 124, an organic insulating layer 126, a first electrode 141, a black layer 142, a liquid crystal layer 151, a second electrode 153, and a second substrate 161.

The gate electrode 111 may be formed on the first substrate 101. The first substrate 101 may be a glass substrate, a quartz substrate, or a plastic substrate, etc. The gate electrode 111 may be a single layer or a stacked structure including aluminum (Al), copper (Cu), molybdenum (Mo), titanium (Ti), chromium (Cr), and/or an alloy thereof, etc.

The gate insulating layer 112 may be formed on the gate electrode 111. The active layer 121 may be formed on the gate insulating layer 112. The gate insulating layer 112 may be a single layer or a stacked structure including silicon oxide (SiOx) and/or silicon nitride (SiNx), etc. The active layer 121 may include semiconductor material, e.g., an amorphous silicon layer doped with impurities.

The source/drain electrodes 123 may be formed on the active layer 121. The source/drain electrodes 123 may be a single layer or a stacked structure including aluminum (Al), copper (Cu), molybdenum (Mo), titanium (Ti), chromium (Cr), and/or an alloy thereof, etc.

The gate electrode 111, the gate insulating layer 112, the active layer 121, and the source and drain electrodes 123 may constitute the TFT 110. The TFT 110 may transfer driving voltages to the liquid crystal. In embodiments, data lines (not shown) may be electrically connected to the source/drain electrodes 123 and/or gate lines (not shown) may be electrically connected to the gate electrode 111. Such data lines and gate lines may be formed on the first substrate 101. The data lines (not shown) and the gate lines (not shown) may include a metal layer, e.g., a same material as the gate electrode 111 and/or the source/drain electrodes 123. In addition to the TFT 110, circuit devices such as a storage capacitor (not shown) may further be formed on the first substrate 101.

The passivation layer 124 may be formed on the source/drain electrodes 123. The passivation layer 124 may be a single layer or a stacked structure including a silicon oxide (SiOx) and/or a silicon nitride (SiNx), etc. The passivation layer 124 may protect the TFT 110 from impurities, moisture, etc. In some embodiments, the passivation layer 124 may not be provided.

The organic insulating layer 126 may be formed on the passivation layer 124. The organic insulating layer 126 may include a transparent organic material, e.g., polyimide, polyvinyl alcohol, poly(vinyl phenol-maleimide), and/or a photoacryl material, etc. The organic insulating layer 126 may insulate the source/drain electrodes 123 from a pixel electrode, e.g., the first electrode 141. In embodiments in which the passivation layer 124 is not provided, the organic insulating layer 126 may be formed on the source/drain electrodes 123 and may function as the passivation layer 124. In some embodiments, a surface of the organic insulating layer 126 may include a convex lens shape portion (see, e.g., dotted line C) in order to collect externally reflected light.

The first electrode 141 may be formed on the organic insulating layer 126. The first electrode 141 may extend between respective portions of the organic insulating layer 126 and the passivation layer 124, and may contact one of the source/drain electrodes 123. The first electrode 141 may be a transparent conductive oxide layer, e.g., indium tin oxide (ITO) and/or indium zinc oxide (IZO), etc. The first electrode 141 may include a non-transparent material, e.g., aluminum (Al), silver (Ag), an Al alloy, an Ag alloy, etc., since the black layer 142 absorbs light that penetrates the liquid crystal layer 151 and prevents light reflection at the first electrode 141. The first electrode 141 may be a pixel electrode that is independently formed for each pixel.

The black layer 142 may be formed on the first electrode 141 and the organic insulating layer 126. The black layer 142 may extend over a surface, e.g., an entire surface, of the first substrate 101. The black layer 142 may include an organic material in which a black colorant is dispersed. The black layer 142 may include, e.g., carbon black. In this regard, e.g., the organic material may include polyimide, polyvinyl alcohol, poly(vinyl phenol-maleimide), and/or a photoacryl material, etc. The black layer 142 may function as a light-absorbing layer and a black matrix.

If a cholesteric liquid crystal is used, the liquid crystal layer 151 may reflect light having a predetermined wavelength due to Bragg reflection (λ=n×P, n: refractive index, and P: pitch of cholesteric liquid crystal) to realize color. If the liquid crystal layer 151 reflects light with a predetermined wavelength and light penetrating the liquid crystal layer 151 is reflected by a metal layer, e.g., the source/drain electrodes 123 stacked on the first substrate 101, all visible light may be reflected, and thus color cannot be realized. However, since the light penetrating the liquid crystal layer 151 may be absorbed in the black layer 142, the absorbed light is not reflected by a metal layer, e.g., the source/drain electrodes 123, on the first electrode 141. Thus, e.g., light of predetermined wavelengths may be selectively reflected by the liquid crystal layer 151. Accordingly, color may be realized without requiring a color filter. In should be understood that in some embodiments a color filter may still be employed.

Cholesteric liquid crystal may be significantly influenced by a fringe field by the first electrode 141 patterned on the first substrate 101. More particularly, when an electric field is applied to the liquid crystal layer 151 by the first electrode 141 and the second electrode 153, the liquid crystal layer 151 between the first electrode 141 and the second electrode 153 may have a homeotropic texture. However, the liquid crystal layer 151 near boundaries of pixels may not have the homeotropic texture due to the fringe field and may have, e.g., a mixed texture of a planar texture and a focal conic texture. Accordingly, when the electric field is removed, the liquid crystal layer 151 may not have a desired texture and/or may not represent a desired gray scale.

In embodiments, the black layer 142 may block light having an undesired gray scale from the fringe field region, e.g., around boundaries of the pixels. By providing the black layer 142 on the first electrode 141, light leakage as a result of, e.g., the fringe field, may be prevented and/or reduced. In addition, embodiments in which the black layer 142 is formed on the first substrate 101 on which the TFT is formed may enable improved alignment of the first substrate 101 and the second substrate 161 during, e.g., assembly of the first substrate 101 and the second substrate 161. More particularly, e.g., embodiments may reduce and/or prevent a reduction in aperture reduction as a result of misalignment of the first substrate 101 and the second substrate 161 during assembly. As a result of, e.g., a reduction in light leakage around boundaries of the pixels and/or improved alignment of the first substrate 101 and the second substrate 161, embodiments may provide improved aperture ratios relative to comparable conventional devices.

The liquid crystal layer 151 may be formed on the black layer 142. The liquid crystal layer 151 may include cholesteric liquid crystal.

The second electrode 153 may be formed on the liquid crystal layer 151. The second electrode 153 may include a transparent conductive oxide layer, e.g., ITO and/or IZO, etc., as the first electrode 141. The second electrode 153 may be a common electrode that is common to a plurality of pixels.

A second substrate 161 may be formed on the second electrode 153. The second substrate 161 may include a glass substrate, a quartz substrate, and/or a plastic substrate, etc., as the first substrate 101.

An alignment layer (not shown) may be disposed between the black layer 142 and the liquid crystal layer 151 and/or between the liquid crystal layer 151 and the second substrate 161.

FIG. 2 illustrates a cross-sectional view of a pixel 200 of a reflection-type liquid crystal display device including cholesteric liquid crystal according to another exemplary embodiment. In general, only differences between the exemplary pixel 100 of FIG. 1 and the exemplary pixel 200 of FIG. 2 will be described below. Referring to FIG. 2, the pixel 200 includes a black organic insulating layer 226 as an organic insulating layer. In such embodiments, the black organic insulating layer 226 may be formed on the passivation layer 124. The black organic insulating layer 226 may include an organic insulating material including a black colorant. In some embodiments, a surface of the black organic insulating layer 226 may include a convex lens shape portion in order to collect light that is externally reflected.

The black layer 142 may formed on the first electrode 141 and the black organic insulating layer 226. In such embodiments, by providing the black organic insulating layer 226 on the first substrate 201 as the organic insulating layer, the black layer 242 and the black organic insulating layer 226 may together function more efficiently as a light-absorbing layer and a black matrix.

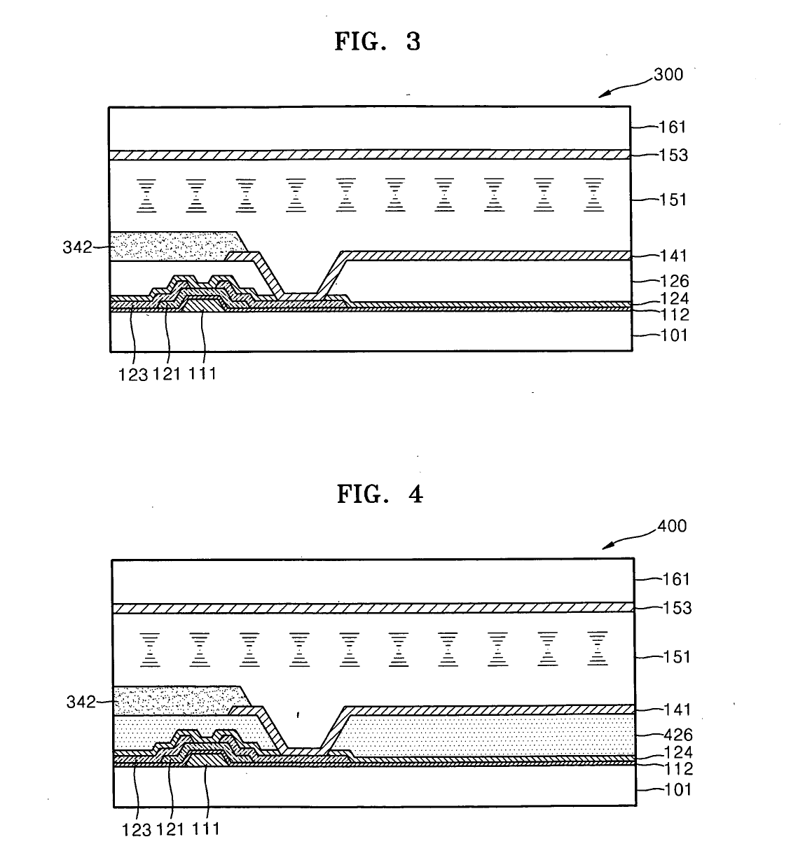

FIG. 3 illustrates a cross-sectional view of a pixel 300 of a reflection-type liquid crystal display device including a cholesteric liquid crystal according to another exemplary embodiment. In general, only differences between the exemplary pixel 100 of FIG. 1 and the exemplary pixel 300 of FIG. 3 will be described below. Referring to FIG. 3, the pixel 300 includes a black layer 342, which formed over a portion, i.e., not over an entire surface, of the first substrate 101. More particularly, the black layer 342 may be formed on the first electrode 141 and the organic insulating layer 126 on a portion of the first substrate 101. The black layer 342 may be patterned so as to screen, i.e., overlap, regions other than an active region through which light is emitted. That is, the black layer 342 may be patterned to screen, i.e., overlap, regions where metal wirings such as TFTs, gate lines, data lines, etc., are aligned at, e.g., boundaries of pixels.

As described above, the black layer 342 may absorb light penetrating a liquid crystal layer 151 such that light is not reflected by a metal layer formed on the first substrate 101 and may prevent and/or reduce light leakage at boundaries of pixels where the alignment of the liquid crystal layer 151 is difficult to control as a result of, e.g., fringe field. In such embodiments, the black layer 342 may function as a light-absorbing layer and a black matrix.

FIG. 4 illustrates a cross-sectional view of a pixel 400 of a reflection-type liquid crystal display device including a cholesteric liquid crystal according to another exemplary embodiment. In general, only differences between the exemplary pixel 100 of FIG. 1 and the exemplary pixel 400 of FIG. 4 will be described below. Referring to FIG. 4, the pixel 400 may include a black organic insulating layer 426 formed over the passivation layer 124. The black organic insulating layer 426 may correspond to an organic insulating layer. The pixel 400 may include the black layer 342 formed over a portion of the first substrate 101, i.e., not over an entire surface of the first substrate 101. The black organic insulating layer 426 may include an organic insulating material including a black colorant. Also, a surface of the organic insulating layer 426 may have a convex lens shape in order to collect light that is externally reflected. In such embodiments, the black organic insulating layer 426 may be formed on the first substrate 101 as an organic insulating layer and the black layer 342 together with the black organic insulating layer 426 may efficiently function as a light-absorbing layer and a black matrix.

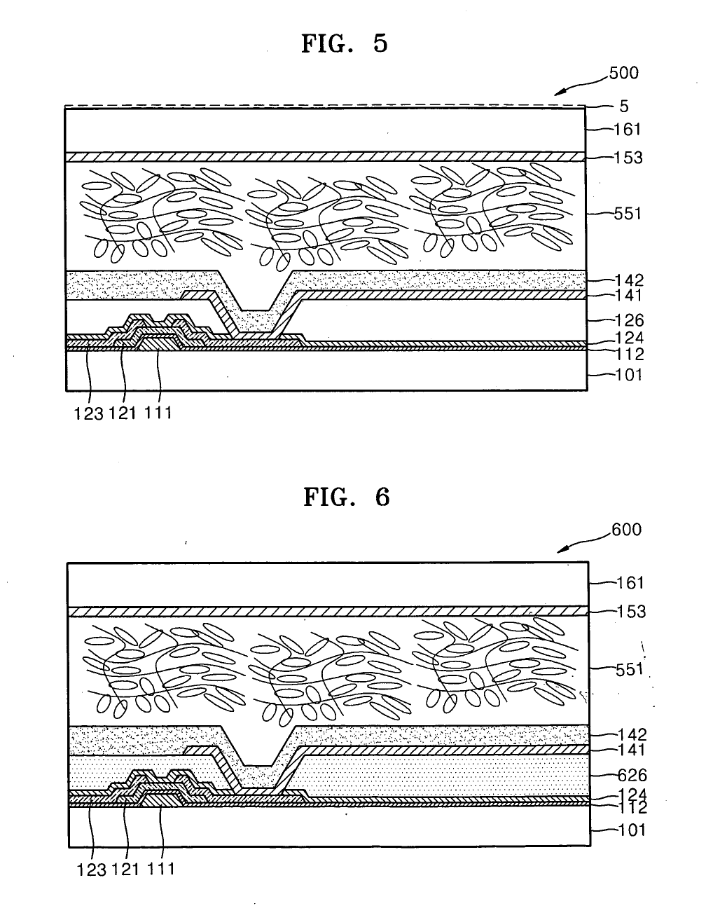

FIG. 5 illustrates a cross-sectional view of a pixel 500 of a reflection-type liquid crystal display device including a polymer network liquid crystal (PNLC) according to another exemplary embodiment. Referring to FIG. 5, the pixel 500 may include a liquid crystal layer 551 including a PNLC. In general, only differences between the exemplary pixel 100 of FIG. 1 and the exemplary pixel 500 of FIG. 5 will be described below.

More particularly, the liquid crystal layer 551 may be formed on the black layer 142. The liquid crystal layer 551 may include a PNLC. The PNLC may include a network structure from polymer in the liquid crystal. When voltages are not applied thereto, molecular alignment of liquid crystal is irregular, and liquid crystal and polymer have different refractive index. As a result, when voltages are not applied thereto, light may be scattered at an interface between liquid crystal and polymer so as to realize white light. When voltages are applied thereto, the liquid crystal may be aligned and a refractive index of the liquid crystal may match with that of the polymer and light may be transmitted to realize black light. Accordingly, in some embodiments, to realize colors, a color filter (dotted line 5) may be disposed on the second substrate 161. Alternatively, in some embodiments, colors may be realized by dispersing dyes in the polymer network liquid crystal layer 551. When voltages are not applied thereto, dyes may be randomly aligned to realize colors due to randomly aligned liquid crystal. When voltages are applied thereto, liquid crystal may be aligned between two upper and lower electrodes in a direction perpendicular to the electrodes, and the dyes may be aligned in the same direction, and thus, black color may be realized.

FIG. 6 illustrates a cross-sectional view of a pixel 600 of a reflection-type liquid crystal display device including a PNLC according to another exemplary embodiment. In general, only differences between the exemplary pixel 600 of FIG. 6 and the exemplary pixel 500 of FIG. 5 will be described below. Referring to FIG. 6, the pixel 600 may include a black organic insulating layer 626 as an organic insulating layer. The black organic insulating layer 626 may be formed on the passivation layer 124. More particularly, in such embodiments, the black organic insulating layer 626 may be formed on the first substrate 601 as the organic insulating layer so that both the black layer 142 and the black organic insulating layer 626 may efficiently function as a light-absorbing layer and a black matrix. The liquid crystal layer 551 may be formed on the black layer 142. The liquid crystal layer 551 may include a PNLC.

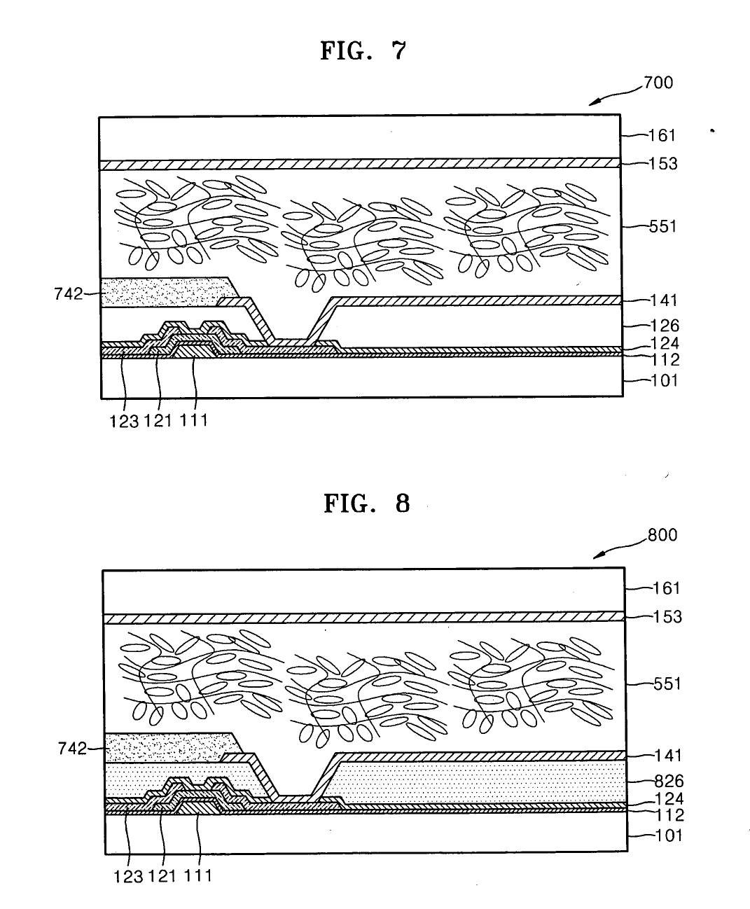

FIG. 7 illustrates a cross-sectional view of a pixel 700 of a reflection-type liquid crystal display device including a PNLC according to another exemplary embodiment. In general, only differences between the exemplary pixel 700 of FIG. 7 and the exemplary pixel 500 of FIG. 5 will be described below. Referring to FIG. 7, the pixel 700 may include a black layer 742 that is formed over a portion, i.e., not over an entire surface, of the first substrate 101. The black layer 742 may be formed on the first electrode 141 and the organic insulating layer 126 over a portion of the first substrate 101. The black layer 742 may be patterned so as to screen, i.e., overlap, regions other than an active region through which light is emitted. That is, the black layer 742 may be patterned to screen, i.e., overlap, regions where, e.g., metal wirings such as TFTs, gate lines, data lines, etc., may be aligned at boundaries of pixels.

As described above, the black layer 742 may absorb light penetrating the liquid crystal layer 551 such that light may not be reflected by a metal layer formed on the first substrate 101 and may prevent light leakage at boundaries of pixels where the alignment of the liquid crystal layer 551 may be difficult to control. That is, the black layer 742 may function as a light-absorbing layer and a black matrix.

FIG. 8 illustrates a cross-sectional view of a pixel 800 of a reflection-type liquid crystal display device including a PNLC according to another exemplary embodiment. In general, only differences between the exemplary pixel 800 of FIG. 8 and the exemplary pixel 700 of FIG. 7 will be described below. Referring to FIG. 8, the pixel 800 may include a black organic insulating layer 826 formed on the passivation layer 124 as an organic insulating layer.

The black layer 742 may be formed on the first electrode 841 and the black organic insulating layer 826 so as to overlap a portion of the first substrate 101. The black layer 742 may be patterned so as to screen, e.g., overlap, regions other than an active region through which light is emitted. For example, the black layer 742 may be patterned to screen regions where, e.g., metal wirings such as TFTs, gate lines, data lines, etc., may be aligned at boundaries of pixels.

As described above, the black layer 742 may absorb light penetrating a liquid crystal layer 551 such that light may not be reflected by a metal layer formed on the first substrate 101 and may prevent and/or reduce light leakage at boundaries of pixels where the alignment of the liquid crystal layer 551 may be difficult to control. That is, the black layer 742 may function as a light-absorbing layer and a black matrix.

More particularly, referring to FIG. 8, the black organic insulating layer 826 may be formed on the first substrate 101 as the organic insulating layer so that both the black layer 742 and the black organic insulating layer 826 may efficiently function as a light-absorbing layer and a black matrix.

In embodiments a black layer may be disposed between a first electrode layer and a liquid crystal layer so that light leakage at boundaries of pixels where the alignment of liquid crystal may be difficult to control. In embodiments, light reflection by a metal layer may be reduced and/or prevented so as to increase aperture ratio and/or reflection contrast ratio. In embodiments, the black layer may be disposed on a first substrate on which a TFT is formed so that a reduction in aperture ratio caused by misalignment when the first substrate and a second substrate are adhered to each other may be reduced and/or prevented.

Embodiments may provide a liquid crystal display device having an improved aperture ratio, e.g., higher aperture ratio, which is a ratio of emission zone per pixel in order to increase the brightness of a screen of the liquid crystal display device and reduce electric power consumption. More particularly, embodiments may provide a liquid crystal display device having a structure such that misalignment of the black matrix during assembly of the array substrate and the opposite substrate may be reduced so as to enable an improved aperture ratio.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A liquid crystal display device, comprising:
a first substrate;
a thin-film transistor on the first substrate, the thin-film transistor including a gate electrode, a gate insulating layer, an active layer, and source and drain electrodes;
an organic insulating layer on the thin-film transistor;
a first electrode layer on the organic insulating layer, the first electrode layer extending between respective portions of the organic insulating layer to contact the source and drain electrodes;
a black layer on the first electrode layer and the organic insulating layer;
a liquid crystal layer on the black layer;
a second electrode layer on the liquid crystal layer; and
a second substrate on the second electrode layer.

2. The liquid crystal display device as claimed in claim 1, wherein the organic insulating layer includes a transparent organic insulating layer.

3. The liquid crystal display device as claimed in claim 1, wherein the organic insulating layer includes a black organic insulating layer.

4. The liquid crystal display device as claimed in claim 1, wherein the organic insulating layer includes a surface having a convex lens shape.

5. The liquid crystal display device as claimed in claim 1, further including a passivation layer between the thin-film transistor and the organic insulating layer.

6. The liquid crystal display device as claimed in claim 1, wherein the black layer is arranged over an entire surface of the first substrate.

7. The liquid crystal display device as claimed in claim 1, wherein the black layer is only arranged over a portion of a surface of the first substrate.

8. The liquid crystal display device as claimed in claim 1, wherein the black layer is arranged over a portion of a surface of the first substrate corresponding to boundaries of pixels.

9. The liquid crystal display device as claimed in claim 1, wherein the black layer includes an organic insulating material or carbon black.

10. The liquid crystal display device as claimed in claim 1, wherein the first electrode layer is a pixel electrode.

11. The liquid crystal display device as claimed in claim 1, wherein the second electrode layer is a common electrode.

12. The liquid crystal display device as claimed in claim 1, wherein the liquid crystal includes a cholesteric liquid crystal layer.

13. The liquid crystal display device as claimed in claim 1, wherein the liquid crystal includes a polymer network liquid crystal (PNLC).

14. The liquid crystal display device as claimed in claim 13, wherein dyes are dispersed in the PNLC.

15. The liquid crystal display device as claimed in claim 1, further comprising a color filter on the second substrate.

16. The liquid crystal display device as claimed in claim 1, wherein the black layer is arranged on the first substrate before the second substrate is arranged on the first substrate.
